(19) United States
(12) Patent Application Publication
(10) Pub. No.: US 2012/0004951 A1
(43) Pub. Date: Jan. 5, 2012

(54) TRACKING METRICS, GOALS AND PERSONAL ACCOMPLISHMENTS USING ELECTRONIC MESSAGES

(75) Inventors: REKHA D. GARAPATI, Jacksonville, FL (US); SUBRAMANIAN KRISHNAMURTHY, New Delhi (IN); ANINDYA NEOGI, New Delhi (IN); ATUL SAXENA, New Delhi (IN)

(73) Assignee: INTERNATIONAL BUSINESS MACHINES CORPORATION, ARMONK, NY (US)

(21) Appl. No.: 12/827,750

(22) Filed: Jun. 30, 2010

(51) Int. Cl. G06Q 10/00; G06F 17/30

(52) U.S. Cl. 705/7.42; 707/812; 707/E17.005; 707/E17.009

(57) ABSTRACT

A method for tracking metrics, goals and personal accomplishments may include receiving, by a processing device, each electronic message tagged by the employee as a personal accomplishment. The method may also include storing each tagged electronic message, by the processing device, in a database associate with a personal accomplishments tracking system. The method may additionally include providing, by the processing device, each tagged electronic message to the employee for sorting and analysis.

### BACKGROUND

Aspects of the present invention relate to tracking metrics, goals, accomplishments and the like usable for personnel evaluations, and more particularly to a method, system and computer program product for tracking metrics, goals and personal accomplishments using electronic messages.

Organizations, such as business enterprises, typically have procedures for periodic goal setting and establishment of business objectives. The period for setting goals and establishing objectives may be annually. To complement the goal setting and establishment of objectives, periodic reviews of the performance and accomplishments of employees toward satisfying personal and organization goals and objectives are conducted. Such reviews are typically at the end of the period which may be about a year. The results of such reviews may be used to determine an employee's future pay packet, eligibility for promotion, or for any type of resource action. A vast amount of information can accumulate over the review period which can present a challenge to organize, prioritize and relate to specific personal and organizational goals and objectives. Managers and employees may also forget about certain accomplishments if not tracked and recorded in some manner.

### BRIEF SUMMARY

According to one aspect of the present invention, a method for tracking metrics, goals and personal accomplishments may include receiving, by a processing device, each electronic message tagged by the employee as a personal accomplishment. The method may also include storing each tagged electronic message, by the processing device, in a database associate with a personal accomplishments tracking system. The method may additionally include providing, by the processing device, each tagged electronic message to the employee for sorting and analysis.

According to another aspect of the present invention, a system for tracking metrics, goals and personal accomplishments may include a processor and a personal accomplishments tracking system, operating on the processor, for tracking personal accomplishments. The personal accomplishments tracking system may be adapted to receive each electronic message tagged as a personal accomplishment. The system may also include a database to store each tagged electronic message associate with the personal accomplishments tracking system. The personal accomplishments tracking system may also be adapted to provide each tagged electronic message to the employee for sorting and analysis at predetermined time intervals.

According to a further aspect of the present invention, a computer program product for tracking metrics, goals and personal accomplishments may include a computer readable storage medium having computer readable program code embodied therewith. The computer readable program code may include computer readable program code configured to receive each electronic message tagged by the employee as a personal accomplishment. The computer readable program code may also include computer readable program code configured to store each tagged electronic message in a database associate with a personal accomplishments tracking system. The computer readable program code may additionally include computer readable program code configured to provide each tagged electronic message to the employee for sorting and analysis at predetermined time intervals.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flowchart of an example of a method for tracking metrics, goals and personal accomplishments in accordance with an embodiment of the present invention.

FIG. 2 is an example of a tag cloud for use in tracking metrics, goals and personal accomplishments in accordance with an embodiment of the present invention.

FIG. 3 is a block schematic diagram of an example of a system for tracking metrics, goals and personal accomplishments in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

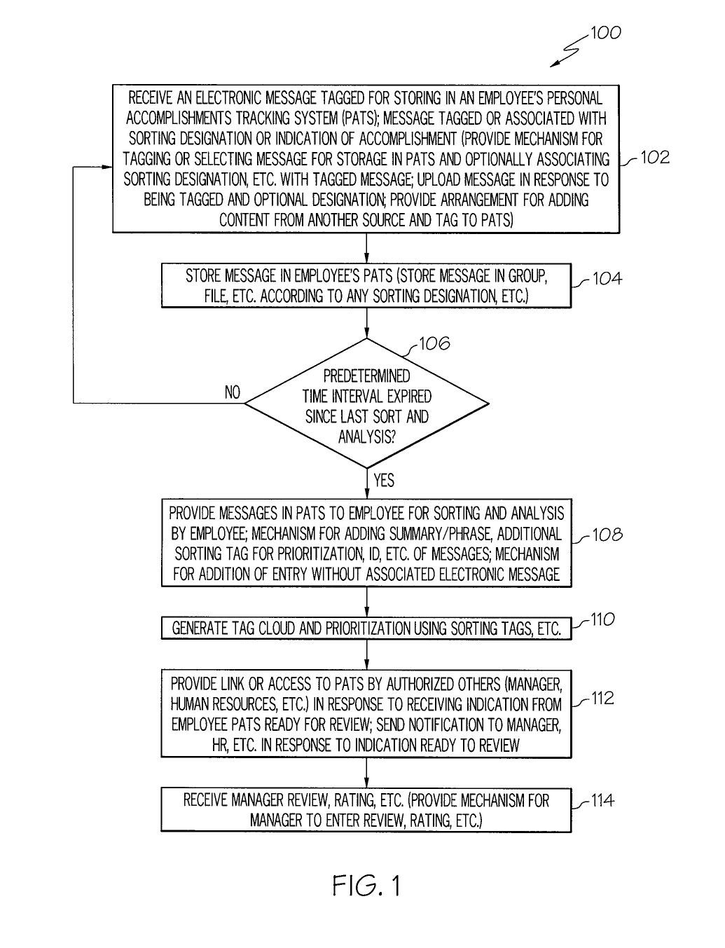

FIG. 1 is a flowchart of an example of a method 100 for tracking metrics, goals and accomplishments in accordance with an embodiment of the present invention. In block 102, an electronic message may be received which has been tagged by an employee for storing in an employee's personal accomplishments tracking system (PATS). The electronic message may be a message that is received by a communications device of the employee. The communications device may be computer system, mobile communications device or any such device capable of receiving electronic messages. Examples of electronic messages may include but is not necessarily limited to email messages, instant messaging (IM) messages, text message, short message service (SMS) messages or any other type electronic messages. Examples of such electronic message applications or system may include but is not limited to Lotus Notes, Yahoo, Google, and Microsoft Outlook. Lotus Notes is a trademark of International Business Machines Corporation in the United States, other countries or both. Yahoo is a trademark of Yahoo, Inc. in the Unites States, other countries or both. Google is a trademark of Google, Inc. in the United States, other countries or both. Microsoft and Outlook are trademarks of Microsoft Corporation in the Unites States, other countries or both.

The message may be tagged or otherwise identified for storing in the employee's PATS by the employee operating a feature of the electronic messaging or email system specifically adapted for this purpose. For example, the feature may be a button, icon, menu item or feature associated with the electronic messaging system to permit selection of the message by the employee for tagging the message as being related to a metric, goal or accomplishment of the employee.

In accordance with an embodiment, the message may be tagged or associated with a designation or indication of the metric, goal or accomplishment. The tag or designation may be used for sorting or automatically sorting the electronic message in the PATS. An arrangement or mechanism, such as a graphical user interface or other computer means, may also be provided for adding content from another source, other than an electronic message, to the PATS. A tag or other designation may also be associated with the content from the other source.

The electronic message may then be stored in a storage device or database. The storage device or database may be local and associated with the employee's communications device. Accordingly, the PATS or portions of the PATS may be local or associated with the employee's communications device. In another embodiment, the electronic message may be uploaded to a server, human resources management system or other system where the PATS may be maintained. The electronic message may then be stored on a storage device associated with the PATS which may be hosted on a server or other processing device.

In block 104, the electronic message may be stored in the employee's PATS or in association with the employee's PATS. As previously described, the message may be stored locally in association with the employee's computer system or communications device or may be uploaded via a network and stored on a system such as a hosted employee PATS. The PATS may be part of or associated with a human resources management system. The message may be stored according to any designation associated with or tagged to the message when uploaded or sent to the PATS. The message may be stored in a group, file, or other sorting arrangement according to any tag or designation associated with the message and according to any sorting scheme, index, classification scheme or the like related to the employee's and/or organization's goals and objectives.

In accordance with an embodiment, the employee may access the PATS to manage the PATS and perform a sort and analysis or other functions. In another embodiment, the employee may at predetermined time intervals during the review period or annual review period be provided an opportunity to review the electronic messages in the employee's PATS and to perform a sort and analysis or to perform any other functions that may be desirable for organizing the electronic messages for tracking the employee's metrics, goals and accomplishments. For example, the predetermined time interval may be quarterly or every 90 days if the review period is annual or yearly. In block 106, a determination may be made if a predetermined time interval has elapsed or expired since the last time the employee performed a sort and analysis of the electronic messages in PATS for tracking the employee's metrics, goals and accomplishments toward satisfying personal and organizational goals and objectives. If the predetermined time interval since the last sort and analysis by the employee has not expired, the method 100 may return to block 102 and additional tagged messages may be received and the method 100 may proceed similar to that previously described.

If the predetermined time interval since the last sort and analysis has expired in block 106, the method 100 may advance to block 108. In block 108, messages in the employee's PATS may be provided to the employee for sorting and analysis. The messages or content may be grouped according to any tags previously associated with each of the messages or content. A mechanism may be provided for adding a key summary sentence or phrase in association with each electronic message or content to represent the inherent accomplishment, metric or goal. The mechanism may be a GUI or other arrangement for adding the summary sentence or phrase in association with each electronic message or content using the employee's communications device or computer system. The mechanism or GUI may also include an arrangement for the employee to enter an additional sorting tag. The additional sorting tag may be used for prioritization, further identification or other purpose. The additional sorting tags may also be used to generate a tag cloud. The GUI may additionally include any other feature to facilitate sorting and organizing the electronic messages for representing the employee's accomplishments toward satisfying personal and organizational goals and objectives. The mechanism or GUI may further include a feature for addition of an entry related to accomplishments of the employee without being associated with an electronic message. The key summary sentences or phrases and set of additional sorting tags may be useful in creating the final accomplishments summary for the review period. The set of additional sorting tags may be generated as a list of the key summary sentences and phrases based on the tag sort list.

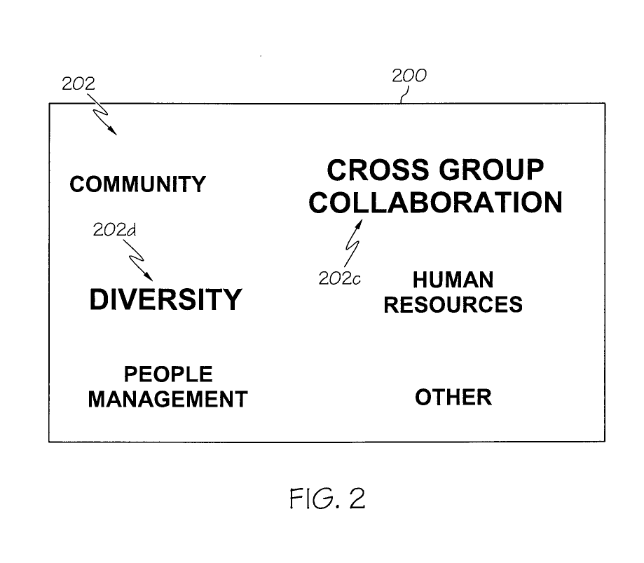

In block 110, a tag cloud may be generated from the tag sort list. An example of a tag cloud including tags usable for sorting and prioritizing the electronic messages is illustrated in FIG. 2. FIG. 2 is an example of a tag cloud 200 for use in tracking metrics, goals and personal accomplishments in accordance with an embodiment of the present invention. A tag cloud is a visual depiction of tags 202, or simply the word content of a website or whatever the tag cloud represents. In this case, the tag cloud may represent different categories or classifications for electronic messages that may be related to different goals or objectives of the employee and the organization. The tag cloud 200 may be used to describe the content of the different goals or objectives or different parameters or metrics that may be used to measure the employee's accomplishments toward personal and organizational goals and objectives. The tags 202 are usually single words but may also include more than one word and are normally listed alphabetically as illustrated in FIG. 2. Non-limiting examples of the tags in the tag cloud 200 include community, cross group collaboration, diversity, human resources, people management and other. The particular tags may be dependent upon the role or function of the employee and the organization and the particular goals and objectives of both. An importance of the tag 202, popularity, weighting or number of electronic messages associated with each tag 202 may be illustrated by a font size of the tag and/or color of the tag. For example, the CROSS GROUP COLLABORATION” tag 202c and the “DIVERSITY” tag 202d in tag cloud 200 would have had the highest importance, weight or number of associated electronic messages compared to the other tags 202 in the tag cloud 200.

Referring back to FIG. 1. In block 112, a link or access to the employee's PATS may be provided to others with authorization, such as for example the employee's manager, human resources or others. The link or access may be provided at all times or may be provided in response to receiving a notification or indication from the employee that his PATS is ready for review. A notification may be sent to the manager, human resources and any others authorized to access and review the PATS of the employee in response to the employee indicating that his PATS is ready for review. The notification may be an automatically generated electronic message, such as an email or other electronic message.

In block 114, the manager's review, rating or the like may be received by the PATS of the employee. A mechanism may be provided for the manager to enter his review or rating for each of the employee's goals and objectives. The mechanism may be a GUI or other arrangement for the manager to perform his review and enter any reviewing remarks, ratings or other indications.

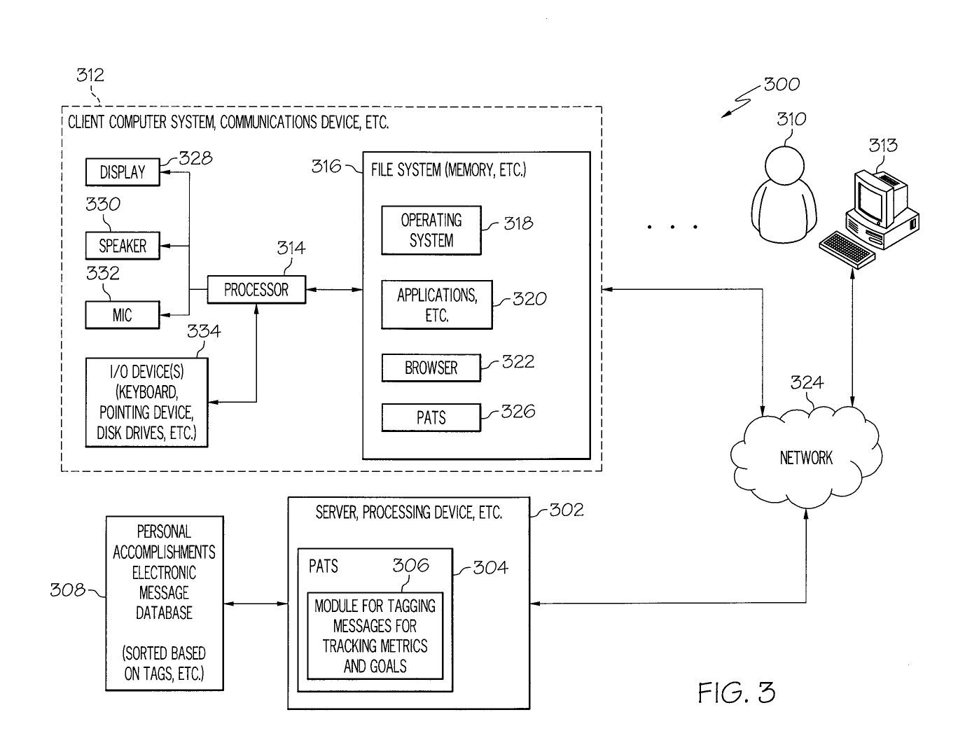

FIG. 3 is a block schematic diagram of an example of a system 300 for tracking metrics, goals and personal accomplishments in accordance with an embodiment of the present invention. The method 100 of FIG. 1 may be embodied in or performed by the system 300. The system 300 may include a processing device 302. The processing device 302 may be a server or similar processing device. A personal accomplishments tracking system (PATS) 304 for tracking metrics, goals and personal accomplishments of an employee may operate on the server or processing device 302. The PATS 304 may be stored on a file system of the processing device 302.

The PATS 304 may include a module 306 for tagging messages for tracking metrics and goals similar to that described herein with reference to the method 100 in FIG. 1. Portions of or all of the method 100 may be embodied in or performed by the PATS 304.

The system 300 may also include a personal accomplishments electronic message database 308 for storing the electronic messages that have been tagged by the employee similar to that previously described. The electronic messages may be sorted in the database 308 according to the tags associated with the messages when initially or first tagged for inclusion in the PATS and any additional tags, such as sorting tags, and any key summaries or phrases or other indicators that may be added during a periodic sort and analysis by the employee similar to that previously described.

An employee or user 310 of the system 300 for tracking metrics, goals and personal accomplishments may use a computer system 312 or communications device to access the processing device 302 or server and PATS 304 for tracking metrics, goals and personal accomplishments. The computer system 312 or communications device may be any sort of communications device including a mobile or handheld computer or communications device. The computer system 312 may include a processor 314 to control operation of the computer system 312 and a file system 316, memory or similar data storage device. An operating system 318, applications 320 and other programs may be stored on the file system 316 for running or operating on the processor 314. A web or Internet browser 322 may also be stored on the file system 316 for accessing the processing device 302 or server via a network 324. The network 324 may be the Internet, an intranet or other private or proprietary network.

In accordance with an embodiment, a PATS 326 may also be stored on the file system 316 and operate on the processor the 314 of the employee's computer system 312. The PATS 326 operating on the computer system 312 may be in place of the PATS 304 hosted on the server 302 or may operate in conjunction with the PATS 304. Accordingly, PATS 326 operating on the computer system 312 may perform some of the functions and operations of the method 100 and PATS 304 operating on the server 302 may perform other functions of the method 100. The personal accomplishments electronic message database 308 may also be local and associated with the user's computer system 312 or may be located somewhere else on the network 324 rather than in association with the server 302 as illustrated in FIG. 3.

The computer system 312 may also include a display 328, a speaker system 330, and a microphone 332 for voice communications. The computer system 314 may also include one or more input devices, output devices or combination input/output devices, collectively I/O devices 334. The I/O devices 334 may include a keyboard or keypad, pointing device, such as a mouse, disk drives and any other devices to permit a user, such as user 310, to interface with and control operation of the computer system 312 and to access the PATS 304.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for tracking metrics, goals and personal accomplishments, comprising:
receiving, by a processing device, each electronic message tagged by the employee as a personal accomplishment;
storing each tagged electronic message, by the processing device, in a database associate with a personal accomplishments tracking system; and
providing, by the processing device, each tagged electronic message to the employee for sorting and analysis.

2. The method of claim 1, wherein providing each tagged electronic message to the employee for sorting and analysis comprises providing each tagged electronic message at predetermined time intervals.

3. The method of claim 1, wherein providing each tagged electronic message to the employee for sorting and analysis comprises providing each tagged electronic message each quarter during an annual review period.

4. The method of claim 1, further comprising:
providing a mechanism for associating a designation with the tagged message; and
uploading the tagged message to the personal accomplishments tracking system in response to the electronic message being tagged and the designation being associated with the tagged electronic message.

5. The method of claim 4, wherein the designation comprises a key term to reference a particular goal or accomplishment to which the electronic message is related.

6. The method of claim 1, further comprising providing a mechanism for associating a summary sentence or phrase with each electronic message to represent the personal accomplishment or goal to which the electronic message is related in response to providing the tagged electronic message to the employee for sorting and analysis.

7. The method of claim 1, further comprising providing a mechanism for associating a sorting tag with each electronic message in response to providing the tagged electronic message to the employee for sorting and analysis, wherein each sorting tag corresponds to at least one of a different goal and accomplishment of the employee.

8. The method of claim 7, further comprising prioritizing each electronic message based on the sorting tag associated with each electronic message.

9. The method of claim 8, further comprising generating a tag cloud using the sorting tags.

10. The method of claim 1, further comprising providing access to the personal accomplishments tracking system of the employee by an authorized person in response to receiving an indication that the personal accomplishments tracking system of the employee is ready for review.

11. A system for tracking metrics, goals and personal accomplishments, comprising:
a processor;
a personal accomplishments tracking system, operating on the processor, for tracking personal accomplishments, the personal accomplishments tracking system being adapted to receive each electronic message tagged as a personal accomplishment; and
a database to store each tagged electronic message associated with the personal accomplishments tracking system, the personal accomplishments tracking system being further adapted to provide each tagged electronic message to the employee for sorting and analysis at predetermined time intervals.

12. The system of claim 11, further comprising a mechanism for associating a designation with the tagged message, the tagged message being uploadable to the personal accomplishments tracking system in response to the electronic message being tagged and the designation being associated with the tagged electronic message.

13. The system of claim 11, further comprising a mechanism for associating a summary sentence or phrase with each electronic message to represent the personal accomplishment or goal to which the electronic message is related in response to providing the tagged electronic message to the employee for sorting and analysis.

14. The system of claim 11, further comprising providing a mechanism for associating a sorting tag with each electronic message in response to providing the tagged electronic message to the employee for sorting and analysis, wherein each sorting tag corresponds to at least one of a different goal and accomplishment of the employee.

15. The system of claim 14, wherein each electronic message is prioritized based on the sorting tag associated with each electronic message.

16. The system of claim 15, wherein the personal accomplishments tracking system is adapted to generate a tag cloud using the sorting tags of each electronic message.

17. A computer program product for tracking metrics, goals and personal accomplishments, the computer program product comprising:
a computer readable storage medium having computer readable program code embodied therewith, the computer readable program code comprising:
computer readable program code configured to receive each electronic message tagged by the employee as a personal accomplishment;
computer readable program code configured to store each tagged electronic message in a database associate with a personal accomplishments tracking system; and
computer readable program code configured to provide each tagged electronic message to the employee for sorting and analysis at predetermined time intervals.

18. The computer program product of claim 17, wherein the computer readable program code further comprises:
computer readable program code configured to provide a mechanism for associating a designation with the tagged message, wherein the designation comprises a key term to reference a particular goal or accomplishment to which the electronic message is related; and
computer readable program code configured to upload the tagged message to the personal accomplishments tracking system in response to the electronic message being tagged and the designation being associated with the tagged electronic message.

19. The computer program product of claim 17, wherein the computer readable program code further comprises:
computer readable program code configured to provide a mechanism for associating a sorting tag with each electronic message in response to providing the tagged electronic message to the employee for sorting and analysis, wherein each sorting tag corresponds to at least one of a different goal and accomplishment of the employee; and
computer readable program code configured to prioritize each electronic message based on the sorting tag associated with each electronic message.

20. The computer program product of claim 17, wherein the computer readable program code further comprises computer readable program code configured to generate a tag cloud using the sorting tags.
